(19) United States
(12) Patent Application Publication
(10) Pub. No.: US 2005/0245550 A1
(43) Pub. Date: Nov. 3, 2005

(54) Fungicidal mixtures based on the dithianon

(76) Inventors: Eberhard Ammermann, Heppenheim (DE); Reinhard Stierl, Freinsheim (DE); Ulrich Schofl, Bruhl (DE); Klaus Schelberger, Gonnheim (DE); Maria Scherer, Godramstein (DE); Michael Henningsen, Frankethal (DE); Randall Even Gold, Obrigheim (DE)

Correspondence Address: BIRCH STEWART KOLASCH & BIRCH, PO BOX 747, FALLS CHURCH, VA, 22040-0747, US

(21) Appl. No.: 10/519,214

(22) PCT Filed: Jun. 30, 2003
(86) PCT No.: PCT/EP03/06888

§ 371 Date: Dec. 27, 2004

(30) Foreign Application Priority Data
Jul. 10, 2002 (DE) 102 31 295.8

(51) Int. Cl. A01N 43/54; A01N 43/64; A01N 43/32

(52) U.S. Cl. 514/266.23; 514/383; 514/434

(57) ABSTRACT

Fungicidal mixtures, comprising
A) the compound of the formula I 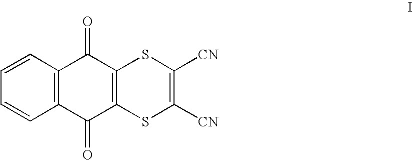 and
B) at least one azole derivative II selected from the group of the compounds II-1 to II-7 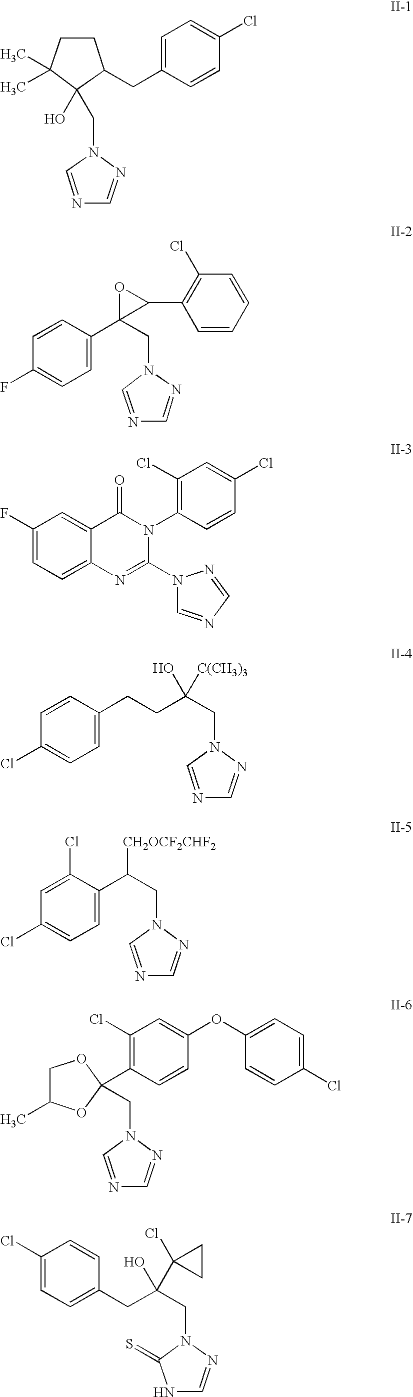 in a synergistically effective amount, methods for controlling harmful fungi using mixtures of the compounds I and II and the use of the compounds I and II for preparing such mixtures are described.

The present invention relates to fungicidal mixtures, comprising
A) the compound of the formula I 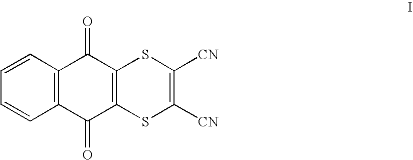
   and
B) at least one azole derivative II selected from the group of the compounds II-1 to II-7 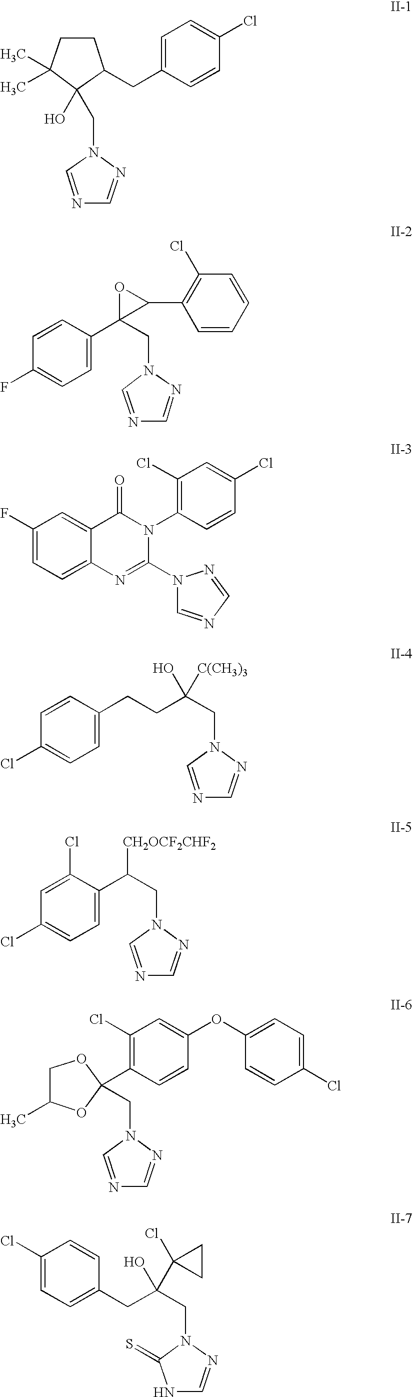
   in a synergistically effective amount.

Moreover, the invention relates to methods for controlling harmful fungi using mixtures of the compounds I and II and to the use of the compounds I and II for preparing such mixtures.

The compound of the formula I (common name: dithianon) and processes for its preparation are described in GB-A 857 383.

The compounds of the formulae II-1 to II-7, their preparation and their action against harmful fungi are likewise known from the literature:

| Compound No. | common name | Literature |
|---|---|---|
| II-1 | metconazole | EP-A 267 778 |
| II-2 | epoxiconazole | EP-A 094 564 |
| II-3 | fluquinconazole | Pesticide Manual, |
| | | 12th Ed., p. 449 (2000) |
| II-4 | tebuconazole | EP-A 040 345 |
| II-5 | tetraconazole | EP-A 234 242 |
| II-6 | difenoconazole | EP-A 065 485 |
| II-7 | prothioconazole | WO-A 96/16048 |

It is an object of the present invention to provide mixtures which have improved activity against harmful fungi combined with a reduced total amount of active compounds applied (synergistic mixtures), with a view to reducing the application rates and broadening the activity spectrum of the known compounds.

We have found that this object is achieved by the mixtures defined at the outset. Moreover, we have found that applying the compounds I and II simultaneously, i.e. together or separately, or applying the compounds I and II in succession provides better control of harmful fungi than is possible with the individual compounds alone.

Usually, mixtures of the compound I with one azole derivative II are used. However, in certain cases mixtures of the compound I with two or more azole derivatives II may be advantageous.

Particular preference is given to the compounds II-1, II-2 and II-3. Especially preferred are mixtures comprising the compound II-1. In another embodiment of the mixtures according to the invention, preference is given to the compound of the formula II-3.

Owing to their basic character, the compounds II-1 to II-7 are capable of forming salts or adducts with inorganic or organic acids or with metal ions.

Examples of inorganic acids are hydrohalic acids, such as hydrogen fluoride, hydrogen chloride, hydrogen bromide and hydrogen iodide, sulfuric acid, phosphoric acid, carbonic acid and nitric acid.

Suitable organic acids are, for example, formic acid, and alkanoic acids, such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, alkylsulfonic acids (sulfonic acids having straight-chain or branched alkyl radicals with 1 to 20 carbon atoms), arylsulfonic acids or aryldisulfonic acids (aromatic radicals, such as phenyl and naphthyl, which carry one or two sulfo groups), alkylphosphonic acids (phosphonic acids having straight-chain or branched alkyl radicals with 1 to 20 carbon atoms), arylphosphonic acids or aryldiphosphonic acids (aromatic radicals, such as phenyl and naphthyl, which carry one or two phosphonic acid radicals), it being possible for the alkyl or aryl radicals to carry further substituents, for example p-toluenesulfonic acid, salicylic acid, p-aminosalicylic acid, 2-phenoxybenzoic acid, 2-acetoxybenzoic acid, etc.

Suitable metal ions are, in particular, the ions of the elements of the second main group, in particular calcium and magnesium, of the third and fourth main group, in particular aluminum, tin and lead, and of the first to eighth transition group, in particular chromium, manganese, iron, cobalt, nickel, copper, zinc and others. Particular preference is given to the metal ions of the elements of the transition groups of the fourth period. The metals can be present in the various valences which they can assume.

When preparing the mixtures, it is preferred to employ the pure active compounds I and II, with which further active compounds against harmful fungi or other pests, such as insects, arachnids or nematodes, or else herbicidal or growth-regulating active compounds or fertilizers can be admixed as required.

The mixtures of the compounds I and II, or the simultaneous joint or separate use of the compounds I and II, have outstanding action against a wide range of phytopathogenic fungi, in particular from the classes of the Ascomycetes, Deuteromycetes, Oomycetes and Basidiomycetes. Some of them act systemically and are therefore also suitable for use as foliar- and soil-acting fungicides.

They are especially important for controlling fungi in a variety of crop plants, such as vegetable species (for example cucumbers, beans and cucurbits), fruit species, grapevine, but also barley, grass, oats, coffee, corn, rye, soya, wheat, ornamentals, sugarcane, and a variety of seeds.

They are particularly suitable for controlling the following phytopathogenic fungi: Erysiphe graminis (powdery mildew) in cereals, Erysiphe cichoracearum and Sphaerotheca fuliginea in cucurbits, Podosphaera leucotricha in apples, Uncinula necator in grapevines, Puccinia species in cereals, Rhizoctonia species in cotton, rice and lawns, Ustilago species in cereals and sugarcane, Venturia inaequalis (scab) in apples, Helminthosporium species in cereals, Septoria nodorum in wheat, Botrytis cinerea (gray mold) in strawberries, vegetables, ornamentals and grapevines, Cercospora arachidicola in groundnuts, Pseudocercosporella herpotrichoides in wheat and barley, Pseudoperonospora species in cucurbits and hops, Plasmopara viticola in grapevines, Alternaria species in vegetables and fruit and Fusarium and Verticillium species.

Furthermore, they can be used in the protection of materials (for example the protection of wood), for example against Paecilomyces variotii.

The compounds I and II can be applied simultaneously, that is either together or separately, or in succession, the sequence, in the case of separate application, generally not having any effect on the control results.

The compounds I and II are usually applied in a weight ratio of from 100:1 to 1:10, preferably from 10:1 to 1:1, in particular from 5:1 to 1:1.

Correspondingly, the application rates of the compound I are usually from 5 to 2 000 g/ha, preferably from 10 to 1 000 g/ha, in particular from 50 to 750 g/ha.

Depending on the nature of the desired effect, the application rates of the mixtures according to the invention are, for the compounds II, from 5 g/ha to 500 g/ha, preferably from 50 to 500 g/ha, in particular from 50 to 200 g/ha.

For seed treatment, the application rates of the mixture are generally from 0.001 to 1 g/kg of seed, preferably from 0.01 to 0.5 g/kg, in particular from 0.01 to 0.1 g/kg.

If phytopathogenic harmful fungi are to be controlled, the separate or joint application of the compounds I and II or of the mixtures of the compounds I and II is effected by spraying or dusting the seeds, the plants or the soils before or after sowing, or before or after plant emergence.

The following are examples of formulations:

1. Products for Dilution with Water

A) Water-Soluble Concentrates (SL)

10 parts by weight of the active compounds are dissolved in water or in a water-soluble solvent. As an alternative, wetters or other auxiliaries are added. The active compound dissolves upon dilution with water.

B) Dispersible Concentrates (DC)

20 parts by weight of the active compounds are dissolved in cyclohexanone with addition of a dispersant, for example polyvinylpyrrolidone. Dilution with water gives a dispersion.

C) Emulsifiable Concentrates (EC)

15 parts by weight of the active compounds are dissolved in xylene with addition of calcium dodecylbenzenesulfonate and castor oil ethoxylate (in each case 5% strength). Dilution with water gives an emulsion.

D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifying machine (Ultraturrax) and made into a homogeneous emulsion. Dilution with water gives an emulsion.

E) Suspensions (SC, OD)

In an agitated ball mill, 20 parts by weight of the active compounds are comminuted with addition of dispersants, wetters and water or an organic solvent to give a fine active compound suspension. Dilution with water gives a stable suspension of the active compound.

F) Water-Dispersible Granules and Water-Soluble Granules (WG, SG)

50 parts by weight of the active compounds are ground finely with addition of dispersants and wetters and prepared as water-dispersible or water-soluble granules by means of technical appliances (for example extrusion, spray tower, fluidized bed). Dilution with water gives a stable dispersion or solution of the active compound.

G) Water-Dispersible Powders and Water-Soluble Powders (WP, SP)

75 parts by weight of the active compounds are ground in a rotor-stator mill with addition of dispersants, wetters and silica gel. Dilution with water gives a stable dispersion or solution of the active compound.

2. Products to be Applied Undiluted

H) Dustable Powders (DP)

5 parts by weight of the active compounds are ground finely and mixed intimately with 95% of finely divided kaolin. This gives a dustable product.

I) Granules (GR, FG, GG, MG)

0.5 part by weight of the active compounds is ground finely and combined with 95.5% of carriers. Current methods are extrusion, spray-drying or the fluidized bed. This gives granules to be applied undiluted.

J) ULV Solutions (UL)

10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetters, adjuvants, herbicides, fungicides, other pesticides, or bactericides may be added to the active compounds, even, if appropriate, not until immediately prior to use (tank mix). These agents can be admixed with the compositions according to the invention typically in a weight ratio of from 1:10 to 10:1.

The fungicidal activity of the compounds and the mixtures can be demonstrated by the following experiments:

The active compounds were prepared separately or jointly as a stock solution comprising 0.25% by weight of active compound in acetone or DMSO. 1% by weight of the emulsifier Uniperol® EL (wetting agent having emulsifying and dispersing action based on ethoxylated alkylphenols) was added to this solution, and the mixture was diluted with water to the desired concentration.

### USE EXAMPLE 1

### Activity Against Gray Mold on Bell Pepper Leaves caused by Botrytis cinerea

Bell pepper seedlings of the cultivar “Neusiedler Ideal Elite” were, after 4-5 leaves were well developed, sprayed to runoff point with an aqueous suspension having the concentration of active compound stated below. The next day, the treated plants were inoculated with a spore suspension of Botrytis cinerea which contained 1.7×10⁶ spores/ml in a 2% strength aqueous biomalt solution. The test plants were then placed in a climatized chamber at 22-24° C. and high atmospheric humidity. After 5 days, the extent of the fungal infection on the leaves could be determined visually in %.

Evaluation was carried out by determining the infected leaf areas in percent. These percentages are converted into efficacies.

The efficacy (E) is calculated as follows using Abbot's formula:
E=(1−α/β)·100
α corresponds to the fungal infection of the treated plants in % and
β corresponds to the fungal infection of the untreated (control) plants in %

An efficacy of 0 means that the infection level of the treated plants corresponds to that of the untreated control plants; an efficacy of 100 means that the treated plants were not infected.

The expected efficacies of the active compound mixtures are determined using Colby's formula [S. R. Colby, Weeds 15, 20-22 (1967)] and compared with the observed efficacies.

Colby's formula:
E=x+y−x·y/100
E expected efficacy, expressed in % of the untreated control, when using the mixture of the active compounds A and B at the concentrations a and b
x efficacy, expressed in % of the untreated control, when using active compound A at a concentration of a

y efficacy, expressed in % of the untreated control, when using active compound B at a concentration of b

TABLE A
Individual active compounds

| | | Concentration of | |
|---|---|---|---|
| | | active compound | Efficacy in % of |
| | | in the spray | the untreated |
| Example | Active compounds | liquor | control |
| 1 | Control | (99% infection) | 0 |
| | (untreated) | | |
| 2 | I (dithianon) | 16 | 0 |
| | | 4 | 0 |
| | | 1 | 0 |
| | | 0.25 | 0 |
| 3 | II-1 | 1 | 49 |
| | (metconazole) | 0.25 | 0 |
| 4 | II-2 | 1 | 9 |
| | (epoxiconazole) | 0.25 | 9 |
| 5 | II-4 | 4 | 0 |
| | (tebuconazole) | 1 | 0 |
| | | 0.25 | 0 |

TABLE B
Combinations according to the invention

| | Active compound | | |
|---|---|---|---|
| | mixture | | |
| | Concentration | Observed | Calculated |
| Example | Mixing ratio | efficacy | efficacy*) |
| 6 | I + II-1 | 19 | 0 |
| | 4 + 0.25 ppm | | |
| | 16:1 | | |
| 7 | I + II-1 | 59 | 49 |
| | 4 + 1 ppm | | |
| | 4:1 | | |
| 8 | I + II-1 | 39 | 0 |
| | 1 + 0.25 ppm | | |
| | 4:1 | | |
| 9 | I + II-1 | 29 | 0 |
| | 0.25 + 0.25 ppm | | |
| | 1:1 | | |
| 10 | I + II-1 | 59 | 49 |
| | 0.25 + 1 ppm | | |
| | 1:4 | | |
| 11 | I + II-2 | 39 | 9 |
| | 4 + 0.25 ppm | | |
| | 16:1 | | |
| 12 | I + II-2 | 49 | 9 |
| | 4 + 1 ppm | | |
| | 4:1 | | |
| 13 | I + II-2 | 39 | 9 |
| | 1 + 0.25 ppm | | |
| | 4:1 | | |
| 14 | I + II-2 | 59 | 9 |
| | 1 + 1 ppm | | |
| | 1:1 | | |
| 15 | I + II-2 | 29 | 9 |
| | 0.25 + 0.25 ppm | | |
| | 1:1 | | |
| 16 | I + II-2 | 44 | 9 |
| | 0.25 + 1 ppm | | |
| | 1:4 | | |
| 17 | I + II-4 | 29 | 0 |
| | 4 + 0.25 ppm | | |
| | 16:1 | | |
| 18 | I + II-4 | 59 | 0 |
| | 16 + 4 ppm | | |
| | 4:1 | | |
| 19 | I + II-4 | 39 | 0 |
| | 4 + 1 ppm | | |
| | 4:1 | | |
| 20 | I + II-4 | 29 | 0 |
| | 1 + 1 ppm | | |
| | 1:1 | | |
| 21 | I + II-4 | 19 | 0 |
| | 0.25 + 0.25 ppm | | |
| | 1:1 | | |
| 22 | I + II-2 | 49 | 0 |
| | 1 + 4 ppm | | |
| | 1:4 | | |

*)efficacy calculated using Colby's formula

### USE EXAMPLE 2

### Activity Against Early Blight of Tomato Caused by Alternaria solani

Leaves of potted plants of the cultivar “Groβe Fleischtomate St. Pierre” were sprayed to runoff point with an aqueous suspension having the concentration of active compounds stated below. The next day, the leaves were infected with an aqueous zoospore suspension of Alternaria solani in 2% biomalt solution having a density of 0.17×10⁶ spores/ml. The plants were then placed in a water-vapor-saturated chamber at temperatures of between 20 and 22° C. After 5 days, the infection on the leaves of the untreated, but infected control plants had developed to such an extent that the infection could be determined visually in %.

TABLE C
Individual active compounds

| | | Concentration of | |
|---|---|---|---|
| | | active compound | Efficacy in % of |
| | | in the spray | the untreated |
| Example | Active compound | liquor [ppm] | control |
| 23 | Control | (81% infection) | 0 |
| | (untreated) | | |
| 24 | I (dithianon) | 4 | 0 |
| | | 1 | 0 |
| | | 0.25 | 0 |
| 25 | II-1 | 1 | 63 |
| | (metconazole) | 0.25 | 2 |
| 26 | II-2 | 1 | 75 |
| | (epoxiconazole) | 0.25 | 63 |
| 27 | II-4 | 1 | 63 |
| | (tebuconazole) | 0.25 | 0 |

TABELLE D
Combinations according to the invention

| | Active compound | | |
|---|---|---|---|
| | mixture | | |
| | Concentration | Observed | Calculated |
| Example | Mixing ratio | efficacy | efficacy*) |
| 28 | I + II-1 | 63 | 2 |
| | 4 + 0.25 ppm | | |
| | 16:1 | | |
| 29 | I + II-1 | 75 | 63 |
| | 4 + 1 ppm | | |
| | 4:1 | | |
| 30 | I + II-1 | 26 | 2 |
| | 1 + 0.25 ppm | | |
| | 4:1 | | |
| 31 | I + II-1 | 63 | 2 |
| | 0.25 + 0.25 ppm | | |
| | 1:1 | | |
| 32 | I + II-1 | 75 | 63 |
| | 0.25 + 1 ppm | | |
| | 1:4 | | |
| 33 | I + II-2 | 75 | 63 |
| | 4 + 0.25 ppm | | |
| | 16:1 | | |
| 34 | I + II-2 | 75 | 63 |
| | 1 + 0.25 ppm | | |
| | 4:1 | | |
| 35 | I + II-2 | 82 | 63 |
| | 0.25 + 0.25 ppm | | |
| | 1:1 | | |
| 36 | I + II-2 | 88 | 75 |
| | 0.25 + 1 ppm | | |
| | 1:4 | | |
| 37 | I + II-4 | 75 | 0 |
| | 4 + 0.25 ppm | | |
| | 16:1 | | |
| 38 | I + II-4 | 26 | 0 |
| | 1 + 0.25 ppm | | |
| | 4:1 | | |
| 39 | I + II-4 | 82 | 63 |
| | 1 + 1 ppm | | |
| | 1:1 | | |
| 40 | I + II-4 | 26 | 0 |
| | 0.25 + 0.25 ppm | | |
| | 1:1 | | |
| 41 | I + II-4 | 75 | 63 |
| | 0.25 + 1 ppm | | |
| | 1:4 | | |

*)efficacy calculated using Colby's formula

The test results show that, for all mixing ratios, the observed efficacy is higher than the efficacy predicted using Colby's formula.

1. A fungicidal mixture, comprising
A) the compound of the formula I 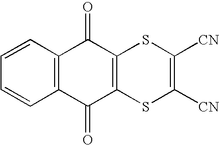
and
B) at least one azole derivative II selected from the group of the compounds II-2, II-3, II-4 and II-7 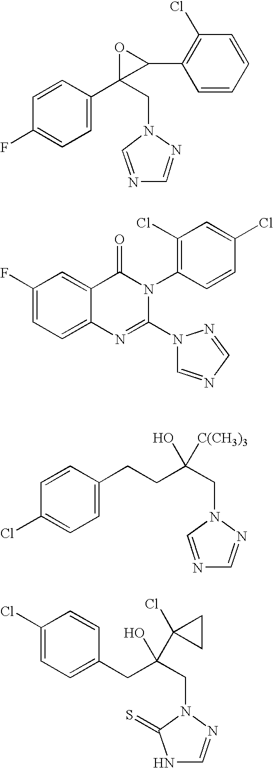
in a synergistically effective amount.

2. A fungicidal mixture as claimed in claim 1, comprising, as azole compound II, the compound of the formula II-2 or II-4.

3. A fungicidal mixture as claimed in claim 1 or 2, wherein the weight ratio of the compound I to the compound II is from 100:1 to 1:10.

4. A fungicidal composition comprising a solid or liquid carrier and a mixture as claimed in claim 1.

5. A method for controlling harmful fungi, which comprises treating the harmful fungi, their habitat, or the plants, seeds, soils, areas, materials or spaces to be kept free from them with the fungicidal mixture as claimed in claim 1.

6. A method as claimed in claim 5, which comprises treating the harmful fungi, their habitat, or the plants, seeds, soils, areas, materials or spaces to be kept free from them with from 5 to 2000 g/ha of the compound I as set forth in claim 1.

7. A method as claimed in claim 5, which comprises treating the harmful fungi, their habitat, or the plants, seeds, soils, areas, materials or spaces to be kept free from them with from 5 to 500 g/ha of at least one compound II as set forth in claim 1.

8. A method for controlling Botritis cinerea as claimed in claim 5.

9. The use of the compounds of the formulae I and II as set forth in claim 1 for preparing a mixture as claimed in claim 1.
